(19) United States
(12) Patent Application Publication
(10) Pub. No.: US 2007/0268890 A1
(43) Pub. Date: Nov. 22, 2007

(54) Integrated Telecommunication Service System

(75) Inventor: Yongkun Liao, Shenzhen City (CN)

Correspondence Address: ERIC CHAN, 42 PIN OAKS DRIVE, PHOENIXVILLE, PA, 19460, US

(73) Assignee: SHENZHEN DONJIN COMMUNICATION TECH CO. LTD., Futian District, Shenzhen City (CN)

(21) Appl. No.: 11/718,799

(22) PCT Filed: Jun. 30, 2006
(86) PCT No.: PCT/CN06/01527

§ 371 Date: May 7, 2007

(30) Foreign Application Priority Data
Jul. 4, 2005 (CN) 200510035799.9

(51) Int. Cl. H04L 12/66

(52) U.S. Cl. 370/352; 370/356

(57) ABSTRACT

An integrated telecommunication service system, including one or more digital signal processing (DSP) modules processing voice signals and signaling and independent from each other. The DSP modules are connected to each other via communication and each of them is also connected to PSTN via communication. Each DSP module is also connected to the Network Switch via communication. The Network Switch is connected to one or more hosts via Ethernet. The hosts include the Configuration Management Module and one or more function modules. Each DSP module has an exclusive IP address. Each function module also has a corresponding IP address. The Configuration Management Module use such IP addresses to establish connection between the modules. The connected modules transmit data to each other via Ethernet protocol frames. The invention can reduce R&D time and provide good expandability by applying Ethernet connection and Configuration Management Module.

### BACKGROUND OF THE INVENTION

This invention relates to the field of communication, to be more specific, an integrated telecommunication service system.

With the development of telecom services, the business focus has been shifted from basic voice services to value-added services for more revenue. Demands for value-added services naturally generate demands for platform equipment of such value-added services. However, the value-added services have the following characteristics:

(1) the service need is usually very urgent, demanding the equipment to be launched quickly. If the service is well accepted, the system needs to be expanded for a large capacity;

(2) the needs for value-added services keep changing rapidly. Typically, a service will be replaced by another in one or two years. Therefore, the equipment cost (including hard costs and soft costs) also plays a key role in determining the success of wide application of the service.

Considering the aforesaid characteristics of the value-added service platform equipment, the current CTI (Computer Telephony Integration) system has three major defects: First, the complexity of API of the system leads to a long R&D period and high soft costs; Second, the imperfect structure design results in a high hard unit cost and thus a high hard cost of equipment for system fabrication; Third, the single-board processing density and the cascade expandability cannot satisfy the need for high density and subsequent expandability of some systems.

### BRIEF SUMMARY OF THE INVENTION

The invention aims to provide an integrated telecommunication service system to reduce R&D time and improve expandability of the current telecom system.

The technical solution of the invention is to provide an integrated telecommunication service system, including one or more digital signal processing (DSP) modules processing voice signals and layer-2 signalings and independent from each other. The DSP modules are connected to and communicate with each other via CT Bus and each of them is also connected to PSTN via communication. Each DSP module is also connected to and communicates with the Network Switch via Ethernet. The Network Switch is connected to one or more hosts via Ethernet. The hosts include the Configuration Management Module and one or more function modules. Each DSP module has an exclusive IP address and each function module also has a corresponding IP address. The Configuration Management Module use such IP addresses to establish connection between the modules. The connected modules transmit data via Ethernet protocol frames.

In such an integrated telecommunication service system, each function module includes a network client side sub-module and a network service side sub-module for communication with other modules and each DSP module includes a master scheduler processing Ethernet protocol frames.

In such an integrated telecommunication service system, one or more function modules sniff and execute control commands from the Configuration Management Module via the network service side sub-modules. The control commands include stopping/starting the current function module.

In such an integrated telecommunication service system, the DSP modules and the function modules have configuration management ports via which they communicate with other modules.

In such an integrated telecommunication service system, one or more function modules have a standard program framework which includes inter-module communication methods, a standard data structure and a standard program process.

In such an integrated telecommunication service system, the standard data structure includes a connection table used to manage status of connection with associated modules.

In such an integrated telecommunication service system, the standard program process includes:

(a) Setting parameters of TCP service side sub-modules and sniffing access of client side of other modules; Adding access of legal client side to the connection table or removing disconnected connection from the table;

(b) Adding access of legal client side to the connection table or removing disconnected connection from the table;

(c) Processing configuration management packets and inter-module communication packets.

In such an integrated telecommunication service system, one or more function modules include a status monitoring module used to detect contents of communication packets between function modules.

In such an integrated telecommunication service system, one or more function modules include a process execution module to realize the system workflow.

In such an integrated telecommunication service system, one or more function modules include a media stream module for recording and playback of streaming data.

The integrated telecommunication service system in this invention can reduce R&D time and improve expandability by replacing current ISA/PCI/CPCI Bus and user API programming with Ethernet connection.

### BRIEF DESCRIPTION OF THE DRAWINGS

FIG. 1 is the overall hardware connection structure of the system.

FIG. 2 is the structure diagram of the Digital Signal Processing Module in FIG. 1.

FIG. 3 is the overall module diagram of the system.

FIG. 4 is the diagram of the Digital Signal Processing Module in FIG. 3.

### DETAILED DESCRIPTION OF THE INVENTION

FIG. 1 represents the overall hardware connection structure of the system.

In this case, the system includes one or more Digital Signal Processing (DSP) Module 11—the minimum hardware unit processing real-time signal (e.g. voice signal). Different DSP modules 11 are independent from each other. DSP modules 11 are connected via CT-BUS for communication between each other. Each of them is also connected to PSTN via communication.

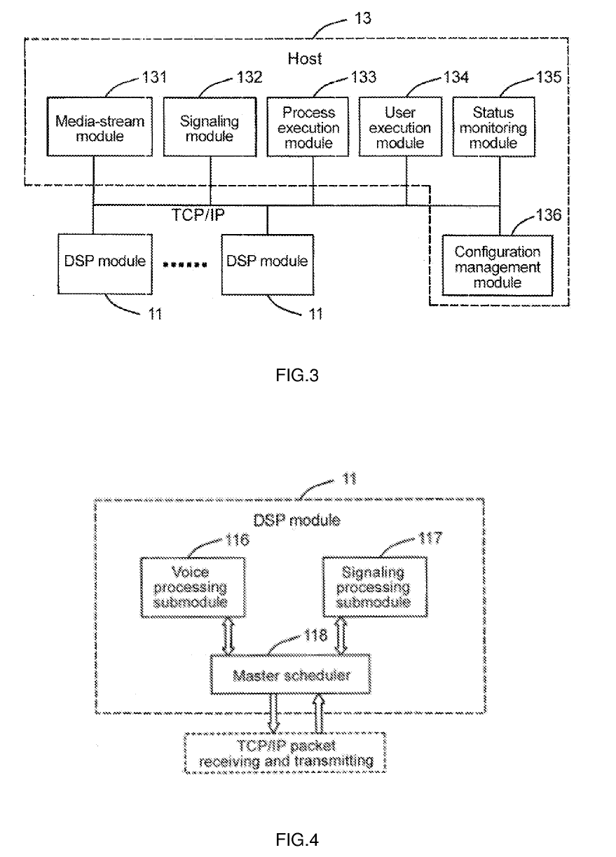

Each DSP Module 11 is also connected to the Network Switch 12 via Ethernet (e.g. twisted pair cable). The Network Switch 12 is connected to one or more Host 13 via Ethernet. Each Host 13 includes one or more function modules (not indicated in FIG. 1) for such functions as recording and playback of streaming data, connection establishment and data frame monitoring (refer to FIG. 3 for detailed descriptions of function modules). The Network Switch 12 can be used as a universal switch for transmission of Ethernet protocol frames.

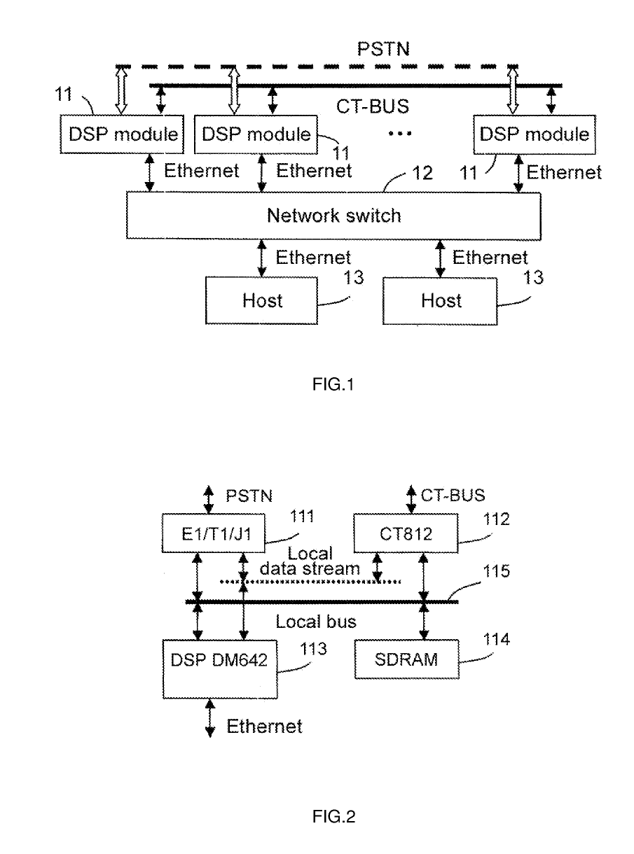

FIG. 2 represents the structure diagram of the Digital Signal Processing Module 11 in FIG. 1. In this case, the DSP Module 11 simultaneously completes processing of voice signals and signalings of layer 2, including E1/T1/J1 PSTN Interface 111, CT812 Chip 112, DM642 Chip 113 and SDRAM 114. E1/T1/J1 PSTN Interface 111, CT812 Chip 112, DS Chip 113 and SDRAM 114 are connected to local bus 115 respectively. DSP Module 11 is connected to PSTN via E1/T1/J1 PSTN Interface 111 and to other DSP modules via CT812 Interface 112. DSP Chip 112 adopts high-performance TMS320DM642 and provides over 4800 MIPS processing capabilities. A single chip can process all signalings and voice signals from four E1 on a real-time basis. In this case, each DSP Module 11 has an exclusive IP address.

FIG. 3 represents the overall module diagram of the system. Host 13 includes multiple function modules, such as Media Streaming Module 131, Signaling Module 132, Process Execution Module 133, User Module 134, Status Monitoring Module 135 and Configuration Management Module 136, which are based on certain hardware to perform specific functions.

Each function module is independent from each other. They can be located on the same Host 13 or distributed on different interconnected hosts. Each function module has the same IP address as the host on which it is installed. If a host has more than one function module on it, such modules have the same IP address and different configuration management terminals. Each function module includes a network client terminal module and network service terminal module (not indicated in the figure) for communication with other modules.

All the above function modules except Configuration Management Module 136 have a standard program framework which is independent from functions of those modules. This can ensure best universality of the integrated telecommunication service system, which satisfies all actual service demands without having to modify programs. You only need to change external definition files and process definitions. The standard framework includes inter-module communication methods, a standard data structure and a standard program process.

In a case of inter-module communication, TCP/IP is applied as communication protocol. Each ITP Module is connected to TCP service side sub-modules associated with modules at lower levels via the TCP client side and to TCP client side associated with modules at higher levels by providing TCP service side sub-modules.

In a case of standard data structure, the standard data structure includes a connection table used to manage status of connection with other associated modules. The connection tables of all modules are classified into three types: a. connection with Configuration Management (one); b. connection with modules at lower levels (one or more); c. connection with modules at higher levels (one or more). The connection table is cleared when a module starts, indicating no valid connection. When a connection is established with another associated module during operation, the corresponding item in the connection table is set to a valid value. The value will be set to 0 upon removal of the connection.

In a case of standard program process, the standard program process includes:

(1) Reading (if necessary) and processing configuration files and initializing data after startup of the modules;

(2) Setting parameters of TCP service side sub-modules and sniffing access of client side of other modules;

(3) Checking access of legal client side to service side sub-modules of the current module and adding such connection (if any) to the connection table of the current module;

(4) Checking if any configuration management packet is received from the Configuration Management Module. If yes, go to Step (5). Go to Step (6) and clear the corresponding item in the connection table if the access is disconnected;

(5) Processing configuration management packets and going to Step (4);

(6) Checking and processing communication packets received from modules at lower levels;

(7) Processing communication packets sent to modules at lower levels;

(8) Checking and processing communication packets received from modules at higher levels and going to Step (3).

Media Stream Module 131 is used for recording and playback of streaming media data based on DSP Module 11. Signaling Module 132 is used to process signaling protocols above Layer 3 of Signaling No. 7 and Q.931 signaling protocol for Digital Signaling No. 1. Process Execution Module 133 is used to control the system workflow and complete CTI services. User Module 134 is used to process such applications irrelevant to CTI functions as database processing. User Module 134 is written by the user and not indispensable in this case. The above Media Stream Module 131, Signaling Module 132, Process Execution Module 133 and User Module 134 are in waiting status after startup, sniff control commands from Configuration Management Module 136 via a port of the network service side sub-modules and execute specific operation according to the received control information.

Configuration Management Module 136 is the core of the integrated telecommunication service system in this invention. Function modules operate according to control commands from Module 136. In this case, each DSP Module 11 has an exclusive MAC address which is bonded to the set IP address by Configuration Management Module 136. In addition, Configuration Management Module 136 can obtain IP address and configuration management port of function modules accessing the system. Configuration Management Module 136, according to the above IP address information and configuration management ports, establishes connection, configures modules, sends address information of associated modules to associated modules and then sends control commands to get the modules started into normal operating process.

In the normal operating process, the configuration management module also conducts such functions as monitoring module operation, stopping/starting and adding/removing modules.

In this case, Media Stream Module 131 can be associated with each DSP Module 11; Signaling Module 132 can be associated with each DSP Module 11; Process Execution Module is associated with DSP Module 11, Media Stream Module 131 and Signaling Module 132. The associated modules transfer information via Ethernet protocol frames to deliver services under the integrated telecommunication service system.

Configuration Management Module 136 can control operating status of function modules, including Disconnected, Connected and Normal. In addition to control and display of operating status of modules, Configuration Management Module 136 also regularly monitors operating status of the running function modules for timely identification of faulty modules.

As described above, Configuration Management Module 136 configures information of modules at lower levels associated with any module, namely modules at lower levels which will be directly used by a module at higher level. After launching, Configuration Management Module 136 will establish communication connection with all the other modules according to configuration information on a real-time basis. Once Configuration Management Module 136 confirms establishment of communication connection with a module, it will send an initialization command to the module and a launch command after successful initialization, mark the module as Running after successful launch, transfer related information of the module to all the running modules at higher levels and transfer related information of all the running modules at higher levels to the module (via module association command packets). With the module association command packets, each module can immediately establish communication with associated modules and use their functions. Configuration Management Module 136 regularly sends heartbeat packets to running modules and requests response from the modules once they receive such heartbeat packets so as to inspect running condition of the modules. Once Configuration Management Module 136 confirms disconnection with a module, it will set the module's status as Disconnected, transfer information of the module to all the related modules at higher and lower levels so that all the related modules can immediately disconnect from the faulty module and stop using its functions. When a module is stopped by user intervention, Configuration Management Module 136 will set the module's status as Disconnected, transfer information of the module to all the related modules at higher and lower levels so that all the related modules can immediately disconnect from the faulty module and stop using its functions. Configuration Management Module 136 enables easier and more convenient expansion of CTI services.

Status Monitoring Module 135 is used to monitor contents of communication packets between other modules in the following way: Status Monitoring Module 135 sends monitoring requests to Configuration Management Module 136 which sends the requests to corresponding function modules. The corresponding modules forward communication packets to Status Monitoring Module 135.

FIG. 4 represents the diagram of the Digital Signal Processing Module 11 in FIG. 3. DSP Module 11, in terms of function, includes Voice Processing Sub-module 116 and Signaling Sub-module 117. Voice Processing Sub-module 116 is used to process all voice signals. Signaling Sub-module 117 includes signaling processing units in four channels and a unit controlling and monitoring format of sending and receiving frames. Three work modes—SS1, DSS1 and SS7 can be set for each signaling processing unit. Each unit processes DL signalings of 30 channels on one E1 port under SS1 Mode, one Q.921 link under DSS1 and one MTP2 link under SS7. The Frame Format Controlling and Monitoring Unit performs control and monitoring of format of sending and receiving signal frames on four E1 ports and alarm processing.

Voice Processing Sub-module 116 and Signaling Processing Sub-module 117 are encapsulated in Ethernet protocol frames by Master Scheduler 118 and sent to function modules for further processing. Or Master Scheduler 118 processes frames from function modules or Configuration Management Module 136 and sends them to Voice Processing Sub-module 116 or Signaling Processing Sub-module 117 for processing.

The above paragraphs are just some examples of practice of the Invention instead of any limitation in any form to the Invention. Any simple modification, amendment, revision, equivalent change or refinement made to the above examples as per the technical essence of the Invention falls into the technical solution and claims of the Invention.

What is claimed is:

1. An integrated telecommunication service system, including one or more digital signal processing (DSP) modules processing voice signals and signalings and independent from each other. The DSP modules are connected to and communicate with each other via CT Bus and each of them is also connected to PSTN via communication. Each DSP module is also connected to and communicates with the Network Switch via Ethernet. The Network Switch is connected to one or more hosts via Ethernet. The hosts include the Configuration Management Module and one or more function modules. Each DSP module has an exclusive IP address and each function module also has a corresponding IP address. The Configuration Management Module use such IP addresses to establish connection between the modules. The connected modules transmit data to each other via Ethernet protocol frames.

2. The integrated telecommunication service system of claim 1, wherein each function module includes a network client side sub-module and a network service side sub-module for communication with other modules; each DSP module includes a master scheduler processing Ethernet protocol frames.

3. The integrated telecommunication service system of claim 1, wherein one or more function modules sniff and execute control commands from the Configuration Management Module via the network service side sub-modules. The control commands include stopping/starting the current function module.

4. The integrated telecommunication service system of claim 1, wherein the DSP modules and the function modules have configuration management ports via which they communicate with other modules.

5. The integrated telecommunication service system of claim 1, wherein one or more function modules have a standard program framework which includes inter-module communication methods, a standard data structure and a standard program process.

6. The integrated telecommunication service system of claim 5, wherein the standard data structure includes a connection table used to manage status of connection with associated modules.

7. The integrated telecommunication service system of claim 6, wherein the standard program process includes:
(a) Setting parameters of TCP service side sub-modules and sniffing access of client side sub-modules of other modules;
(b) Adding access of legal client side sub-modules to the connection table or removing disconnected connection from the table;
(c) Processing configuration management packets and inter-module communication packets.

8. The integrated telecommunication service system of claim 1, wherein one or more function modules include a status monitoring module used to detect contents of communication packets between function modules.

9. The integrated telecommunication service system of claim 1, wherein one or more function modules include a process execution module to realize the system workflow.

10. The integrated telecommunication service system of claim 1, wherein one or more function modules include a media stream module for recording and playback of streaming data.
